(19) United States
(12) Patent Application Publication
(10) Pub. No.: US 2025/0335026 A1
(43) Pub. Date: Oct. 30, 2025

(54) INFORMATION PROCESSING SYSTEM AND INFORMATION PROCESSING METHOD FOR A VEHICLE

(71) Applicant: AIRBUS (BEIJING) ENGINEERING CENTRE COMPANY LIMITED, Beijing (CN)

(72) Inventor: Jinming HUANG, Beijing (CN)

(21) Appl. No.: 19/188,680

(22) Filed: Apr. 24, 2025

(30) Foreign Application Priority Data
Apr. 26, 2024 (CN) 202410516447.8

(51) Int. Cl. G06F 3/01; B64D 43/00; G09G 3/00

(52) U.S. Cl. CPC G06F 3/013; B64D 43/00; G09G 3/001; G09G 2354/00; G09G 2380/12

(57) ABSTRACT

An information processing system and an information processing method for a vehicle are disclosed including a generation unit configured to generate an image in response to an input command; a communication unit configured to receive and transmit the image generated by the image generation unit and image-related information based on the input command; a projection unit coupled to the communication unit and configured to project the image based on the image-related information; and a flexible display unit configured to stretch out or retract under control of a control switch. The flexible display unit stretches out and displays the image projected by the projection unit when the control switch is turned on, and the flexible display unit retracts and does not display an image when the control switch is turned off.

This application claims priority to Chinese Patent Application No. 202410516447.8, titled “INFORMATION PROCESSING SYSTEM AND INFORMATION PROCESSING METHOD FOR A VEHICLE”, filed on Apr. 26, 2024, with the China National Intellectual Property Administration, which is incorporated herein by reference in its entirety.

### FIELD

The present disclosure relates to the field of flight, and in particular to an information processing system and an information processing method for a vehicle.

### BACKGROUND

At present, a Head up Display (HUD) system has achieved rapid development and is widely used. The HUD system may be used in a vehicle to provide display-enhanced information. The head up display technology can be used to directly project significant information, such as, vehicle information, turn instructions, lane departure warnings, navigation, road conditions and telephone calls, etc., into the eyesight of the operator of the vehicle (such as a driver of a vehicle or a pilot), making the operator be able to acquire driving information only through looking straight ahead without lowering his head or turning his head, allowing the operator to pay maximum attention to the flight situation, effectively improve safety.

In the traditional HUD technology, reflection imaging is usually implemented with a windshield. A surface curvature of the windshield distorts an image entering eyes through the windshield, and thus the image observed by the driver does not conform to the original design, so as to affect the user experience of the HUD.

In the aviation field, air traffic control coordinates and guides flight routes and flight modes of different aircraft in the airspace or airport by air traffic controllers on the ground, in order to prevent accidents of aircraft on the ground or in the air, and ensure smooth operation of aircraft, thereby achieving maximum efficiency. Usually, an air traffic control (ATC) system or an operation control center (OCC) communicates with an aircraft through voice based on radio communication. Such communication is non-intuitive and lacks interaction.

Therefore, it is required to provide an information processing system and an information processing method with improved interactivity and enhanced display.

### SUMMARY

A brief summary of the present disclosure is given hereinafter, so as to provide basic understanding in some aspects of the present disclosure. It should be understood that this overview is not an exhaustive overview of the present disclosure. It is neither intended to determine a critical part or an important part of the present disclosure, nor to limit the scope of the present disclosure. An object of the overview is only to give some concepts in a simplified manner, which serves as a preface of a more detailed description described later.

In view of the above issues, the present disclosure provides an interactive, display-enhanced information processing system, information processing method, computer-readable storage medium and aircraft configured with the information processing system or coupled to the above information processing system.

According to an aspect of the present disclosure, an information processing system for a vehicle is provided. The information processing system comprises an image generation unit configured to generate an image in response to an input command; a communication unit configured to receive and transmit the image generated by the image generation unit and image-related information based on the input command; a projection unit coupled to the communication unit and configured to project the image based on the image-related information; and a flexible display unit configured to stretch out or retract under control of a control switch, wherein the flexible display unit stretches out and displays the image projected by the projection unit when the control switch is turned on, and the flexible display unit retracts and does not display an image when the control switch is turned off.

According to an embodiment of the present disclosure, the information processing system further comprises a monitoring device. The monitoring device comprises one or more sensors configured to monitor at least one of characteristic information of an operator of the vehicle and environmental information of the vehicle; an event determination unit configured to, determine whether a predetermined event has occurred, based on at least one of the information monitored by the one or more sensors and a driving mode of the vehicle received by the monitoring device; and an event notification unit configured to generate a notification indicating the occurrence of the predetermined event, and transmit the notification to the image generation unit for visual display, in a case that the event determination unit determines that the predetermined event has occurred.

According to an embodiment of the present disclosure, the characteristic information of the operator comprises at least one of a posture, a voice, and an eye movement of the operator.

According to an embodiment of the present disclosure, the one or more sensors monitor the eye movement of the operator.

According to an embodiment of the present disclosure, the event determination unit determines whether an eyeball deviation event has occurred based on information of the eye movement of the operator monitored by the one or more sensors; where, the event determination unit determines that the eyeball deviation event has occurred, in a case of determining that eyeballs of the operator deviate from an eyebox region of a head up display device arranged on the vehicle; and where, the event notification unit generates, when determining that the eyeball deviation event has occurred, a notification indicating the occurrence of the eyeball deviation event.

According to an embodiment of the present disclosure, the image-related information comprises at least one of priority information and event notification information.

According to an embodiment of the present disclosure, any of the priority information and the urgency for an event is preset.

According to an embodiment of the present disclosure, the communication unit comprises at least one of an optical system, a wireless communication system, and a wired communication system.

According to an embodiment of the present disclosure, the flexible display unit is arranged in front of a front windshield of the vehicle and is transparent.

According to an embodiment of the present disclosure, the projection unit is configured to differentially project the image based on one of the priority information and the urgency for an event.

According to an embodiment of the present disclosure, the image generation unit is further configured to generate the image in response to at least one of the input command and an input image from an external device connected to the vehicle.

According to an embodiment of the present disclosure, the vehicle is an aircraft.

According to an aspect of the present disclosure, an information processing method for a vehicle is provided. The information processing method comprises: generating an image in response to an input command; transmitting the generated image and image-related information based on the input command; projecting the image based on the image relevant information; and controlling, by a control switch, a flexible display unit to stretch out or retract for display, where, the flexible display unit stretches out and displays the projected image when the control switch is turned on, and the flexible display unit retracts and does not display the image when the control switch is turned off, wherein the control switch and the flexible display unit are arranged in the vehicle.

According to an embodiment of the present disclosure, the information processing method further comprises: monitoring at least one of characteristic information of an operator of the vehicle and environmental information of the vehicle; determining whether a predetermined event has occurred based on at least one of the monitored information and a driving mode of the vehicle; and generating a notification indicating the occurrence of the predetermined event and transmitting the notification for visual display, in a case of determining that the predetermined event has occurred.

According to an embodiment of the present disclosure, the image-related information comprises at least one of priority information and event notification information.

According to an embodiment of the present disclosure, the event notification information comprises at least one of a notification indicating occurrence of an event and the urgency for an event.

According to an embodiment of the present disclosure, any of the priority information and the urgency of an event is preset.

According to an embodiment of the present disclosure, the information processing method further comprises generating the image in response to at least one of the input command and an input image from an external device connected to the vehicle.

According to an aspect embodiment of the present disclosure, a computer-readable storage medium is provided. The computer-readable storage medium stores a program. The program is used to cause a computer system to perform the information processing method described above.

According to an aspect embodiment of the present disclosure, an aircraft including the information processing system described above is further provided.

Other aspects of embodiments of the present disclosure are given in the following description. The detailed description is for sufficiently disclosing preferred embodiments of the present disclosure instead of limiting the present disclosure.

### BRIEF DESCRIPTION OF THE DRAWINGS

To further set forth the above and other advantages and features of the present disclosure, detailed description will be made in the following for the specified implementation of the present disclosure in conjunction with drawings. The drawings, together with the detailed description below, are incorporated into and form a part of the specification. Components with identical functions or structures are designated by identical reference signs. It should be noted that the drawings only illustrate typical embodiments of the present disclosure and should not be construed as a limitation to the scope of the present disclosure. In the drawings:

FIG. 1 is a block diagram illustrating an exemplary structure of an information processing system for a vehicle according to an embodiment of the present disclosure.

FIG. 2 is a schematic diagram illustrating mapping between an image in an eyebox plane and an image in a retina plane of a pilot.

FIG. 3A is a schematic diagram illustrating an information processing system according to an embodiment of the present disclosure applied to an aircraft.

FIG. 3B is a schematic diagram illustrating an optical transmission path of an information processing system according to an embodiment of the present disclosure.

FIG. 4 is a block diagram illustrating a functional configuration example of a monitoring device for a vehicle according to an embodiment of the present disclosure.

FIG. 5 is a flowchart illustrating a monitoring method according to an embodiment of the present disclosure.

FIG. 6 is a flowchart illustrating an information processing method according to an embodiment of the present disclosure.

FIG. 7 is a block diagram of an exemplary structure of a general-purpose personal computer in which a method and/or apparatus according to an embodiment of the present disclosure may be implemented.

### DETAILED DESCRIPTION

An exemplary embodiment of the present disclosure will be described hereinafter in conjunction with the drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the drawings, and other details having little relationship to the present disclosure are omitted.

Embodiments of the present disclosure are described in detail below in conjunction with the drawings.

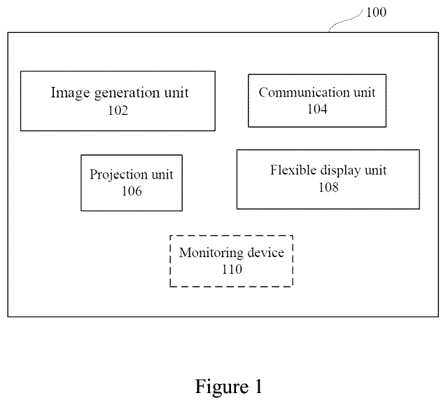

First, an implementation example of an information processing system 100 for a vehicle according to the present disclosure are described with reference to FIG. 1. FIG. 1 is a block diagram illustrating a functional configuration example of an information processing system 100 for a vehicle according to an embodiment of the present disclosure.

As shown in FIG. 1, the information processing system 100 according to the embodiment of the present disclosure may comprise an image generation unit 102, a communication unit 104, a projection unit 106 and a flexible display unit 108.

The image generation unit 102 may be configured to generate an image in response to an input command. The input command may be an command sent by the vehicle to the information processing system 100, and may further be an command received from an external device connected to the vehicle.

For example, the vehicle may be an aircraft, such as a passenger aircraft, a cargo aircraft or a helicopter. The input command may be an command sent by a controller of an air traffic control (ATC) system or a controller of an operation control center (OCC). The image generation unit 102 may generate, in response to the input command, an image such as a taxiing route map for pilot navigation.

According to another embodiment of the present disclosure, the image generation unit 102 may be configured to generate an image in response to the input command and an input image from an external device connected to the vehicle. For example, if the input image is an image that the controller of the ATC system or the controller of the OCC expects to share with the vehicle, the image generation unit 102 may generate, in response to the input image, an image including same information as the input image. In this way, the controller of the ATC system or the controller of the OCC can intuitively share an image with the aircraft, such as a flight route map, thereby improving the efficiency of guiding the flight routes and flight modes of different aircraft in the airspace or airport.

The communication unit 104 may be configured to receive the information from various units within the information processing system or external devices and transmits information between them. For example, the communication unit 104 may be configured to receive and transmit the image generated by the image generation unit 102 and information related to the image generated in response to the input command, wherein the information related to the generated image (i.e., image-related information) may comprise at least one of priority information and event notification information, wherein the event notification information may comprise at least one of a notification indicating occurrence of an event and the urgency for an event.

It should be understood that any of the priority information and the urgency of an event may be preset by pilots, aircraft maintenance staff, or control staff.

According to an embodiment of the present disclosure, the communication unit may include at least one of an optical system, a wireless communication system, and a wired communication system. According to an embodiment of the present invention, and the communication unit may be an optical system that uses waveguide optical devices commonly referred to as optical waveguides for light transmission. The optical waveguides project electromagnetic waves within a visible part of an electromagnetic spectrum. It should be understood that the present disclosure is not limited to this, and other types of communication unit may further be used in the present disclosure.

The projection unit 106 is coupled to the communication unit 104, and may be configured to project the image based on the image-related information. According to the embodiment of the present disclosure, the projection unit 106 may map a received image in an eyebox plane to an image in a retina plane of a pilot, to project the image onto the flexible display unit. Finally, light beam projected onto the flexible display unit is reflected into eyes of the pilot.

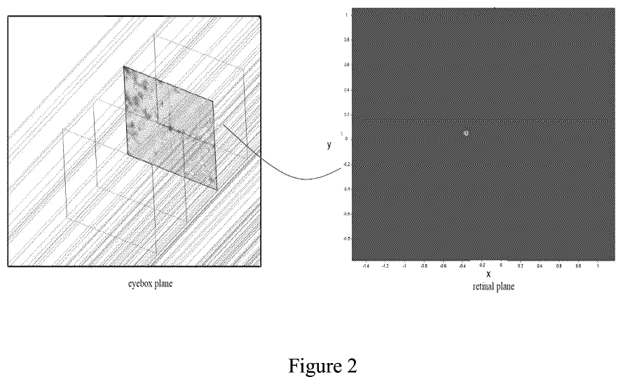

FIG. 2 is a schematic diagram illustrating mapping between an image in an eyebox plane and an image in a retina plane for a pilot. An image in an eyebox plane transmitted to the projection unit through the communication unit 104 is schematically illustrated on the left side of FIG. 2. The image mapped into a retina plane for a pilot is schematically illustrated on the right side of FIG. 2.

According to an embodiment of the present disclosure, the projection unit 106 may be configured to perform differential projection based on one of the priority information and the urgency for an event. For example, in a case that there is an obstacle around the aircraft, a relative distance between the aircraft and the obstacle is closer, the symbology representing the obstacle (e.g., the obstacle icon) is larger in size in the image projected by the projection unit 106, in order to alert the pilot.

The flexible display unit 108 may stretch out and retract by one press button, wherein the flexible display unit 108 may stretch out or retract under control of a control switch. Specifically, the flexible display unit 108 may stretch out and display the image projected by the projection unit 106 when the control switch is turned on, and the flexible display unit 108 may retract and not display an image when the control switch is turned off. According to the embodiment of the present disclosure, the flexible display unit 108 may be transparent.

According to an embodiment of the present disclosure, optionally, the information processing system 100 may further comprise a monitoring device 110. The configuration for the monitoring device 110 will be described below and will not be described in detail herein.

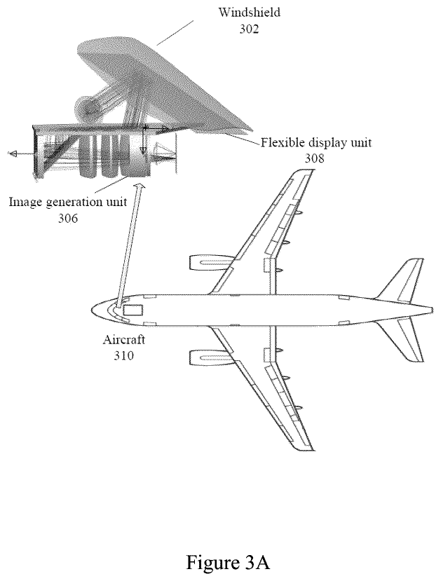

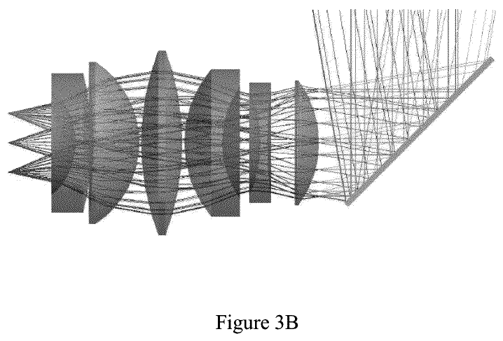

FIG. 3A is a schematic diagram illustrating an information processing system according to an embodiment of the present disclosure applied to an aircraft. The flexible display unit 308 may be arranged at a position close to a sun visor plate between the pilot and a windshield 302. The optical transmission between the image generation unit 306, the projection unit, and the flexible display unit 308 is schematically shown in FIG. 3A.

FIG. 3B is a schematic diagram illustrating an optical transmission path of an information processing system according to an embodiment of the present disclosure. The information processing system according to the embodiment of the present disclosure has a smaller size and is suitable to be deployed in a constrained space.

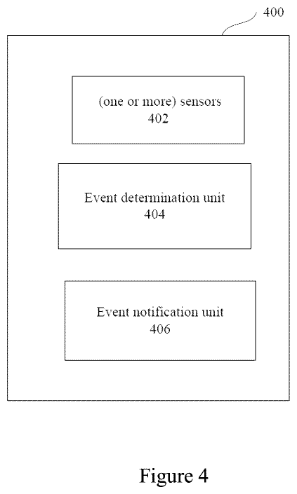

Hereinafter, a monitoring device 400 for a vehicle according to the embodiment of the present disclosure is described with reference to FIG. 4. FIG. 4 is a block diagram illustrating an example for the functional configuration of a monitoring device for a vehicle according to an embodiment of the present disclosure.

As shown in FIG. 4, the monitoring device 400 for a vehicle according to the embodiment of the present disclosure may comprise one or more sensors 402, an event determination unit 404 and an event notification unit 406.

The one or more sensors 402 may be configured to monitor at least one of characteristic information of an operator of the vehicle and environmental information of the vehicle, wherein the characteristic information of the operator may comprise at least one of a posture, a voice, and an eye movement of the operator.

For example, the one or more sensors 402 may be arranged inside or outside a cabin of the aircraft, or disposed on a wearable device worn by the pilot, and configured to monitor at least one of the posture, the voice, and the eye movement of the pilot, e.g. monitoring the gesture of the pilot, etc.

The event determination unit 404 may be configured to determine whether a predetermined event has occurred based on at least one of the information monitored by the one or more sensors 402 and a driving mode of the vehicle (i.e., the operation mode of the vehicle) received by the monitoring device 400.

According to an embodiment of the present disclosure, a graphic symbology corresponding to the driving mode may be displayed on a head up display device of the aircraft based on different driving modes (such as a taxi mode, a parking mode, a landing mode, etc) of the aircraft.

The event notification unit 406 may be configured to generate a notification indicating occurrence of the predetermined event, and transmit the notification for visual display, in a case that the event determination unit 404 determines the occurrence of the predetermined event.

According to an embodiment of the present disclosure, a near-infrared light sensor arranged in front of a seat of the pilot may be configured to track the eye movement of the pilot. When the event determination unit 404 determines that the pilot's eyeballs deviate the eyebox region of the head up display device arranged on the aircraft (e.g. the pilot's eyesight is out of boundary the eyebox region), the event determination unit 404 determines that an eyeball-deviation event has occurred.

When the event determination unit 404 determines that an eyeball-deviation event has occurred, the event determination unit 404 transmits an event determination result to the event notification unit 406. The event notification unit 406 may generate a notification indicating occurrence of the eye-deviation event and transmit the notification.

It should be recognized that the monitoring device 400 for the vehicle according to the present disclosure may be implemented as part of the above-mentioned information processing system 100 (that is, operating as the monitoring device 110 shown in FIG. 1).

In the case that the information processing system 100 comprises the optional monitoring device 110 and the predetermined event occurs, the event notification unit of the monitoring device 110 transmits the notification indicating the occurrence of the predetermined event (for example, switching of the driving mode) to the image generation unit of the information processing system 100 for processing, thereby visually displaying the image for notifying the occurrence of the predetermined event.

For example, when an event for switching the driving mode of the aircraft occurs, the event notification unit of the monitoring device 110 transmits, to the information processing system 100, the notification indicating occurrence of the event in a form of commands. The image generation unit 102, the projection unit 104, and the flexible display unit 106 in the information processing system 100 may process as discussed above to visually notify the pilot of the switching of the driving mode. For example, a current driving mode of the aircraft is highlighted or the symbology representing a change in the driving mode flashes on the display unit to notify the pilot of the switching of the driving mode.

The monitoring device 400 for a vehicle according to the present disclosure may also operate independently of the information processing system 100 according to the present disclosure. In a case that the predetermined event occurs, the event notification unit 406 of the monitoring device 400 may transmit the notification indicating the occurrence of the predetermined event to other systems different from the information processing system 100 according to the present disclosure for visual display.

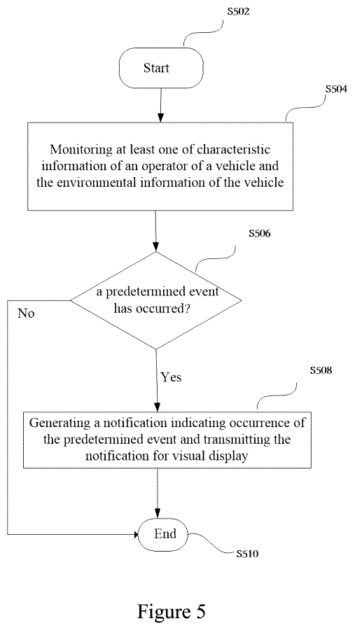

FIG. 5 is a flowchart illustrating a monitoring method corresponding to the above-mentioned monitoring device 400. As shown in FIG. 5, the monitoring method 500 according to the embodiment of the present disclosure may start at step S502 and may comprise steps S504 to S508.

In step S504, at least one of the characteristic information of the operator of the vehicle and the environmental information of the vehicle is monitored. The step S504 may be performed by the one or more sensors 402 in the monitoring device 400 according to the embodiment of the present disclosure described above. Therefore, the specific details may be referred to the above description and will not be described in detail herein.

In step S506, it is determined whether the predetermined event has occurred based on at least one of the monitored information and the driving mode of the vehicle. The step S506 may be performed by the event determination unit 404 in the monitoring device 400 according to the embodiment of the present disclosure described above. Therefore, the specific details may be referred to the above description and will not be described in detail herein.

In a case of determining that the predetermined event has occurred in step S506 (that is, Yes in step S506), the process proceeds to step S508. In step S508, the notification indicating the occurrence of the predetermined event is generated, and the notification is transmitted for visual display. The step S508 may be performed by the event notification unit 406 in the monitoring device 400 according to the embodiment of the present disclosure described above. Therefore, the specific details may be referred to the above description and will not be described in detail herein.

On the other hand, in a case of determining that no predetermined event has occurred (that is, No in step S506) in step S506, the process ends (step S510).

Corresponding to the above-mentioned information processing system 100 according to the embodiments of the present disclosure with reference to FIGS. 1 to 3, an information processing method for a vehicle is further provided according to the present disclosure.

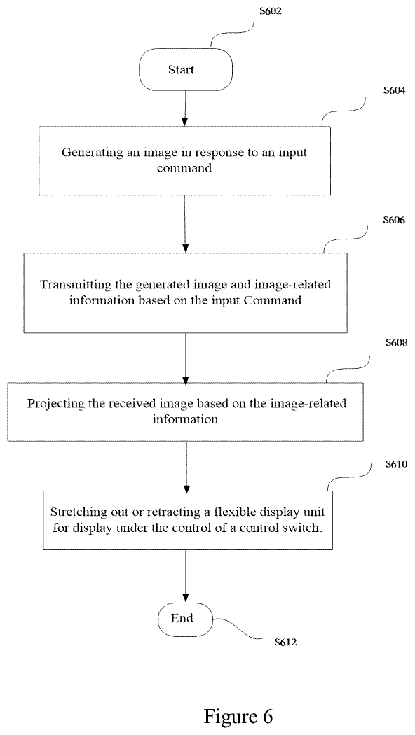

FIG. 6 is a flowchart illustrating an exemplary flow of an information processing method 600 according to an embodiment of the present disclosure. As shown in FIG. 6, the information processing method 600 according to the embodiment of the present disclosure may start at step S602 and may comprise steps S604 to S610.

In step S604, an image is generated in response to an input command. The input command may be an command sent by the vehicle to the information processing system, and may further be an command received from an external device connected to the vehicle. The step S604 may be performed by the image generation unit 102 described above. Therefore, the specific details may be referred to the above description and will not be described in detail herein.

In step S606, the generated image and image-related information based on the input command are transmitted, wherein the information related to the generated image (i.e., image-related information) may comprise at least one of priority information and event notification information, and the event notification information may comprise at least one of a notification indicating occurrence of an event and the urgency for an event. The step S606 may be performed by the communication unit 104 described above. Therefore, the specific details may be referred to the above description and will not be described in detail herein.

In step S608, the received image is projected based on the image-related information. The step S608 may be performed by the projection unit 106 described above. The specific details may be referred to the above description and will not be described in detail herein.

In step S610, a flexible display unit stretches out or retracts for display under control of the control switch. The flexible display unit stretches out and displays the projected image when the control switch is turned on, and the flexible display unit retracts and does not display the image when the control switch is turned off, wherein the control switch and the flexible display unit are arranged in the vehicle. The flexible display unit 108 may be opened by one touch. According to an embodiment of the present disclosure, the flexible display unit 108 may be transparent. The step S610 may be performed by the flexible display unit 108 described above, the specific details may be referred to the above description and will not be described in detail herein.

Then, the information processing method 600 may end at step S612.

In an embodiment, according to the information processing method 600 of the embodiment of the present disclosure, monitoring processing as described in the above monitoring method 500 may be performed before proceeding to step S604, and then visual display is performed based on a monitored event (such as a change in the driving mode of the aircraft) in steps S604 to S610.

The methods discussed above may be implemented completely by a computer-executable program, or may be partially or completely implemented by hardware and/or firmware.

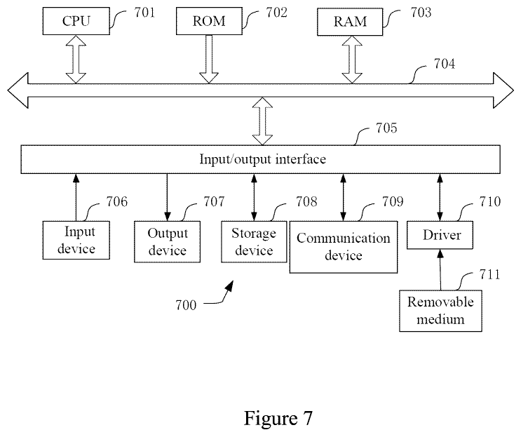

Various modules and units in the above device or system may be configured by software, firmware, hardware or a combination thereof. Specific means or methods for configuring are well known to those skilled in the art, and are not described in detail herein. In a case that the above configuration is implemented by software or firmware, a program constituting the software is installed from a storage medium or network to a computer (for example, a general-purpose personal computer 700 as shown in FIG. 7) with a dedicated hardware structure. The computer is configured to perform various functions when being installed with various programs.

FIG. 7 is a block diagram of an exemplary structure of a general-purpose personal computer in which a method and/or network according to an embodiment of the present disclosure may be implemented.

As shown in FIG. 7, a central processing unit (CPU) 701 executes various processing according to a program stored in a read-only memory (ROM) 702 or a program loaded to a random access memory (RAM) 703 from a storage device 708. The data needed for the various processing of the CPU 701 may be stored in the RAM 703 as needed. The CPU 701, the ROM 702 and the RAM 703 are linked with each other via a bus 704. An input/output interface 705 is also linked to the bus 704.

The following components are linked to the input/output interface 705: an input device 706 (including keyboard, mouse and the like), an output device 707 (including displays such as a cathode ray tube (CRT), a liquid crystal display (LCD), a loudspeaker and the like), a storage device 708 (including hard disc and the like), and a communication device 709 (including a network interface card such as a LAN card, modem and the like). The communication device 709 performs communication processing via a network such as the Internet.

A driver 710 may also be linked to the input/output interface 705, if needed. If needed, a removable medium 711, for example, a magnetic disc, an optical disc, a magnetic optical disc, a semiconductor memory and the like, may be installed in the driver 710, so that the computer program read therefrom is installed in the storage device 708 as appropriate.

In a case that the above-mentioned series of processing is implemented through software, programs forming the software are installed from a network such as the Internet or a memory medium such as the removable medium 711.

It should be appreciated by those skilled in the art that the memory medium is not limited to the removable medium 711 shown in FIG. 7, which has program stored therein and is distributed separately from the apparatus so as to provide the programs to users.

The removable medium 711 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 702 and the storage device 708 in which programs are stored, and can be distributed to users along with the device in which they are incorporated.

Computer program codes and a computer program product storing machine-readable instruction codes are further provided according to the present disclosure. The instruction codes, when read and executed by a machine, perform the method according to the embodiment of the present disclosure described above.

Accordingly, a storage medium configured to carry the program product in which machine-readable instruction codes are stored is also included in the present disclosure. The storage medium includes but is not limited to a floppy disc, an optical disc, a magnetic optical disc, a memory card and a memory stick.

Preferred embodiments of the present disclosure have been described above with reference to the drawings. However, the present disclosure is not limited to the above embodiments. Those skilled in the art may make various alternations and modifications within the scope of the appended claims. It should be understood that these alternations and modifications shall naturally fall within the technical scope of the present disclosure.

For example, multiple functions implemented by one unit in the above embodiments may be implemented by separate apparatus. Alternatively, multiple functions implemented by multiple units in the above embodiments may be implemented by separate apparatus, respectively. Furthermore, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in other order appropriately.

From the above description, the following technical solutions are provided according to the embodiment of the present disclosure, but are not limited thereto.

Solution 1, an information processing system for a vehicle, comprises:
an image generation unit configured to generate an image in response to an input command;
a communication unit configured to receive and transmit the image generated by the image generation unit and image-related information based on the input command;
a projection unit, coupled to the communication unit and configured to project the image based on the image-related information; and
a flexible display unit configured to stretch out or retract under control of a control switch, wherein the flexible display unit stretches out and displays the image projected by the projection unit when the control switch is turned on, and the flexible display unit retracts and does not display an image when the control switch is turned off.

Solution 2. The information processing system according to solution 1, further comprises a monitoring device, wherein the monitoring device comprises:
one or more sensors configured to monitor at least one of characteristic information of an operator of the vehicle and environmental information of the vehicle;
an event determination unit configured to, determine whether a predetermined event has occurred, based on at least one of the information monitored by the one or more sensors and a driving mode of the vehicle received by the monitoring device; and
an event notification unit configured to generate a notification indicating the occurrence of the predetermined event, and transmit the notification to the image generation unit for visual display, in a case that the event determination unit determines that the predetermined event has occurred.

Solution 3. The information processing system according to solution 2, the characteristic information of the operator comprises at least one of a posture, a voice, and an eye movement of the operator.

Solution 4. The information processing system according to solution 3, the one or more sensors monitor the eye movement of the operator.

Solution 5. The information processing system according to solution 4, the event determination unit determines whether an eyeball deviation event has occurred based on information of the eye movement of the operator monitored by the one or more sensors; where, the event determination unit determines that the eyeball deviation event has occurred, in a case of determining that eyeballs of the operator deviate from an eyebox region of a head up display device arranged on the vehicle; and where, the event notification unit generates, when determining that the eyeball deviation event has occurred, a notification indicating the occurrence of the eyeball deviation event.

Solution 6. The information processing system according to solution 1, wherein the image-related information comprises at least one of priority information and event notification information.

Solution 7. The information processing system according to solution 6, wherein the event notification information comprises at least one of a notification indicating occurrence of an event and the urgency for an event.

Solution 8. The information processing system according to solution 7, wherein either the priority information or the urgency of an event is preset.

Solution 9. The information processing system according to solution 1, wherein the communication unit comprises at least one of an optical system, a wireless communication system, and a wired communication system.

Solution 10. The information processing system according to solution 1, wherein the flexible display unit is arranged in front of a front windshield of the vehicle and is transparent.

Solution 11. The information processing system according to solution 8, wherein the projection unit is configured to differentially project the image based on one of the priority information and the urgency of an event.

Solution 12. The information processing system according to solution 1, wherein the image generation unit is further configured to generate the image in response to at least one of the input instruction and an input image from an external device connected to the vehicle.

Solution 13. The information processing system according to any one of solutions 1 to 12, the vehicle is an aircraft.

Solution 14, an information processing method for a vehicle comprises
generating an image in response to an input command;
transmitting the generated image and image-related information based on the input command;
projecting the image based on the image relevant information; and
controlling, by a control switch, a flexible display unit to stretch out or retract for display,
wherein the flexible display unit stretches out and displays the projected image when the control switch is turned on, and the flexible display unit retracts and does not display the image when the control switch is turned off, wherein the control switch and the flexible display unit are arranged in the vehicle.

Solution 15, the information processing method according to solution 14, further comprises:
monitoring at least one of characteristic information of an operator of the vehicle and environmental information of the vehicle;
determining whether a predetermined event has occurred based on at least one of the monitored information and a driving mode of the vehicle; and
generating a notification indicating the occurrence of the predetermined event and transmitting the notification for visual display, in a case of determining that the predetermined event has occurred.

Solution 16. The information processing method according to solution 14, wherein the image-related information comprises at least one of priority information and event notification information.

Solution 17. The information processing method according to solution 16, wherein the event notification information comprises at least one of a notification indicating occurrence of an event and the urgency for an event.

Solution 18. The information processing method according to solution 17, wherein either the priority information or the urgency of an event is preset.

Solution 19. The information processing method according to solution 14 further comprises generating the image in response to at least one of the input command and an input image from an external device connected to the vehicle.

Solution 20. A computer-readable storage medium stores a program, when executed by a computer, causes the computer to perform the information processing method according to any one of solutions 14 to 19.

Solution 21. A monitoring method for a vehicle, comprises:
monitoring at least one of characteristic information of an operator of a vehicle and environmental information of the vehicle;
determining whether a predetermined event has occurred based on at least one of the monitored information and a driving mode of the vehicle; and
generating a notification indicating occurrence of the predetermined event and transmitting the notification for visual display, in a case of determining that the predetermined event has occurred.

Solution 22. The monitoring method according to solution 21, wherein the characteristic information of the operator comprises at least one of a posture, a voice, and an eye movement of the operator.

Solution 23. A monitoring device for a vehicle, comprises:
one or more sensors configured to monitor at least one of characteristic information of an operator of the vehicle and environmental information of the vehicle;
an event determination unit configured to, determine whether a predetermined event has occurred, based on at least one of the information monitored by the one or more sensors and a driving mode of the vehicle; and
an event notification unit configured to generate a notification indicating the occurrence of the predetermined event, and transmit the notification to an image generation unit for visual display, in a case that the event determination unit determines that the predetermined event has occurred.

Solution 24. The monitoring device according to solution 23, wherein the characteristic information of the operator comprises at least one of a posture, a voice, and an eye movement of the operator.

Solution 25. The monitoring device according to solution 24, wherein the one or more sensors monitor the eye movement of the operator.

Solution 26. The monitoring device according to solution 25, wherein the event determination unit determines whether an eyeball deviation event has occurred based on information of the eye movement of the operator monitored by the one or more sensors; where, the event determination unit determines that the eyeball deviation event has occurred, in a case of determining that eyeballs of the operator deviate from an eyebox region of a head up display device arranged on the vehicle; and where, the event notification unit generates, when determining that the eyeball deviation event has occurred, a notification indicating the occurrence of the eyeball deviation event.

Solution 27. The monitoring device according to any one of solutions 23 to 26, wherein the vehicle is an aircraft.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in conjunction with the drawings, it shall be appreciated that the embodiments as described above are merely illustrative rather than limitative of the present disclosure. Those skilled in the art can make various modifications and variations to the above embodiments without departing from the essence and scope of the present disclosure. Therefore, the scope of the present disclosure is defined by the appended claims and their equivalents.

1. An information processing system for a vehicle, comprising:
an image generation unit configured to generate an image in response to an input command;
a communication unit configured to receive and transmit the image generated by the image generation unit and an image-related information based on the input command;
a projection unit coupled to the communication unit and configured to project the image based on the image-related information; and
a flexible display unit configured to stretch out or retract under control of a control switch, wherein the flexible display unit stretches out and displays the image projected by the projection unit when the control switch is turned on, and the flexible display unit retracts and does not display the image when the control switch is turned off.

2. The information processing system according to claim 1, further comprising a monitoring device, wherein the monitoring device comprising:
one or more sensors configured to monitor at least one of a characteristic information of an operator of the vehicle and an environmental information of the vehicle;
an event determination unit configured to determine whether a predetermined event has occurred based on at least one of the information monitored by the one or more sensors and a driving mode of the vehicle received by the monitoring device; and
an event notification unit configured to generate a notification indicating the occurrence of the predetermined event and transmit the notification to the image generation unit for visual display, in a case that the event determination unit determines that the predetermined event has occurred.

3. The information processing system according to claim 2, wherein the characteristic information of the operator comprises at least one of a posture, a voice, and an eye movement of the operator.

4. The information processing system according to claim 3, wherein the one or more sensors monitor an eye movement of the operator.

5. The information processing system according to claim 4, wherein
the event determination unit determines whether an eyeball deviation event has occurred based on the information of the eye movement of the operator monitored by the one or more sensors;
wherein, the event determination unit determines that the eyeball deviation event has occurred, in a case of determining that eyeballs of the operator deviate from an eyebox region of a head up display device arranged on the vehicle; and
wherein, the event notification unit generates, when determining that the eyeball deviation event has occurred, a notification indicating the occurrence of the eyeball deviation event.

6. The information processing system according to claim 1, wherein the image-related information comprises at least one of a priority information and an event notification information.

7. The information processing system according to claim 6, wherein the event notification information comprises at least one of a notification indicating occurrence of an event and the urgency of the event.

8. The information processing system according to claim 7, wherein the priority information and the urgency of the event is preset.

9. The information processing system according to claim 1, wherein the communication unit comprises at least one of an optical system, a wireless communication system, and a wired communication system.

10. The information processing system according to claim 1, wherein the flexible display unit is arranged in front of a front windshield of the vehicle and is transparent.

11. The information processing system according to claim 8, wherein the projection unit is configured to differentially project the image based on one of the priority information and the urgency of the event.

12. The information processing system according to claim 1, wherein the image generation unit is further configured to generate the image in response to at least one of the input command and an input image from an external device connected to the vehicle.

13. The information processing system according to claim 1, wherein the vehicle is an aircraft.

14. An information processing method for a vehicle, comprising:
generating an image in response to an input command;
transmitting the generated image and an image-related information based on the input command;
projecting the image based on the image-related information; and
controlling, by a control switch, a flexible display unit to stretch out or retract for display,
wherein, the flexible display unit stretches out and displays the projected image when the control switch is turned on, and the flexible display unit retracts and does not display the image when the control switch is turned off, wherein the control switch and the flexible display unit are arranged in the vehicle.

15. The information processing method according to claim 14, further comprising:
monitoring at least one of a characteristic information of an operator of the vehicle and an environmental information of the vehicle;
determining whether a predetermined event has occurred based on at least one of the monitored information and a driving mode of the vehicle; and
generating a notification indicating the occurrence of the predetermined event and transmitting the notification for visual display, in a case of determining that the predetermined event has occurred.

16. The information processing method according to claim 14, wherein the image-related information comprises at least one of a priority information and an event notification information.

17. The information processing method according to claim 16, wherein the event notification information comprises at least one of a notification indicating occurrence of an event and the urgency for the event.

18. The information processing method according to claim 17, wherein the priority information and the urgency of the event is preset.

19. The information processing method according to claim 14, further comprising:
generating the image in response to at least one of the input command and an input image from an external device connected to the vehicle.

20. A computer-readable storage medium storing a program, wherein the program, when executed by a computer, causes the computer to perform the information processing method according to claim 14.
